(19) United States
(12) Patent Application Publication
(10) Pub. No.: US 2014/0095295 A1
(43) Pub. Date: Apr. 3, 2014

(54) METHOD AND SYSTEM FOR IMPLEMENTING CALENDAR OPTIMIZATION

(71) Applicant: Oracle International Corporation, Redwood Shores, CA (US)

(72) Inventors: Bart FELDMAN, Lexington, MA (US); Nadav ZIVELIN, Menlo Park, CA (US); Christopher Ward DAHLBERG, Carlisle, MA (US); Brian Hayden HARGRAVES, Guilford, CT (US); Sofia MARIAMOVA, Rishon Lezion (IL)

(73) Assignee: Oracle International Corporation, Redwood Shores, CA (US)

(21) Appl. No.: 14/039,591

(22) Filed: Sep. 27, 2013

Related U.S. Application Data
(60) Provisional application No. 61/707,830, filed on Sep. 28, 2012.
(60) Provisional application No. 61/780,664, filed on Mar. 13, 2013.

(51) Int. Cl. G06Q 30/02

(52) U.S. Cl. CPC G06Q 30/0244
USPC 705/14.43

(57) ABSTRACT

Disclosed is an improved approach to implement and handle promotion optimization by an enterprise software application. Promotion optimization functionality is provided to permit customer controlled rules to be processed for the promotions. The promotion optimization functionality in some embodiments include adding exclusions sets, improving the buy-down calculation, increased flexibility when entering event costs, better support for different causal types, and/or new parameters that provide greater flexibility.

### CROSS-REFERENCE TO RELATED APPLICATIONS

The present application claims the benefit of priority to U.S. Provisional Patent Application No. 61/707,830, entitled “METHOD AND SYSTEM FOR IMPLEMENTING CALENDAR OPTIMIZATION” (Attorney Docket No. ORA130371-US-PSP), filed on Sep. 28, 2012; and the present application claims the benefit of priority to U.S. Provisional Patent Application No. 61/780,664, entitled “METHOD AND SYSTEM FOR IMPLEMENTING CALENDAR OPTIMIZATION” (Attorney Docket No. ORA130371-US-PSP-1), filed Mar. 13, 2013, both of which are hereby incorporated by reference in their entirety.

### BACKGROUND

The present application relates to software development and more specifically to systems, methods, and computer program products for implementing enterprise software applications.

Many types of business logic are implemented by enterprise software applications. For example, many enterprise applications are focused on business logic to perform marketing or customer relations management (CRM) tasks. Examples of such business logic include tools that facilitate sales planning, financial analysis, web-based customer surveys, cataloging, and order capture.

The goal of many of these enterprise software applications is, of course, to help an organization improve its business prospects and increase sales/revenue. If being able to sell a product is the basis of a given business, then effective management of the selling process across the business becomes critical to the organization's success. Effective selling is the continuous dialogue of marketing, promotion, proposal, contract, fulfillment, service, and much more, where appropriate enterprise planning, analysis, and access to sufficient information drives selling success.

A significant part of the modern selling process pertains to the proper use of promotions and sales incentives for the sales activities. A sales promotion is an activity, process, or incentive item(s) that attempt to provide added value or incentives to consumers, wholesalers, retailers, or other organizational customers to stimulate sales. These promotion efforts can be used to stimulate product interest or purchase. The promotions may be directed to any entity within the selling process, including for example, customers, sales organizations and staff, distribution people and organizations, channel members, and consumers.

To be effective, the enterprise software application must include logic that properly facilitates the selling process. Accurate data must be available at the right place, at the right time, and must be easily and efficiency accessible by the users of the system.

With regard to sales promotions, the enterprise software application must be able to provide an effective mechanism to optimize the way in which promotions are handled and implemented by an organization. In addition, the enterprise software application needs to provide an effective way to optimize the calendaring of the promotions.

### SUMMARY

The present application provides an improved approach to implement and handle promotion optimization by an enterprise software application. In some embodiments, promotion optimization functionality is provided to permit customer controlled rules to be processed for the promotions. The promotion optimization functionality in some embodiments include adding exclusions sets, improving the buy-down calculation, increased flexibility when entering event costs, better support for different causal types, and/or new parameters that provide greater flexibility.

Calendar Optimization is also provided in some embodiments, which enables users to optimize more than one promotion at a time. The optimization functionality can be used to suggest a full calendar of promotions, based on specific business rules.

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 shows an architecture of a system for implementing promotion optimization functionality according to some embodiments of the invention.

FIG. 2 shows a high level diagram of the setup flow for promotion optimization according to some embodiments of the invention.

FIG. 3 shows an example table used in conjunctions with the embodiment of FIG. 2.

FIG. 4 illustrates example optimization parameters that can be configured.

FIG. 5 illustrates a setup flow for calendar optimization.

FIG. 6 illustrates example input attributes/arguments and output attributes/arguments that can be configured.

FIG. 7 shows an example approach to view/edit the workflow definitions, along with a partial list of workflow steps that can be viewed/edited.

FIG. 8 shows an example approach to view/configure the optimization definitions.

FIG. 9 shows a process flow to perform the calendar optimization.

FIG. 10 illustrates an example approach to open and configure the optimization worksheet.

FIG. 11 shows an example approach to choose the “Call Calendar Optimizer” method.

FIG. 12 illustrates an example approach to define a population for the optimization.

FIG. 13 shows an example approach for executing the calendar optimization.

FIG. 14a shows an example interface to view optimization results.

FIG. 14b shows an example interface to display Promotion Calendar information.

FIG. 14c shows an example interface to display Investment Across Products information.

FIG. 14d shows an example interface to display Detailed Report information.

FIG. 15 shows an example approach to save the promotions and to clear the results.

FIG. 16 is a block diagram of an illustrative computing system suitable for implementing an embodiment of the present invention.

### DETAILED DESCRIPTION

As noted above, there is a need for an enterprise software application to be able to provide an effective mechanism to optimize the way in which promotions are handled and implemented by an organization. In addition, the enterprise software application needs to provide an effective way to optimize the calendaring of the promotions.

The present application provides an improved approach to implement and handle promotion optimization by an enterprise software application. In addition, embodiments of the present invention provides for calendar optimization that enables users to optimize more than one promotion at a time. The optimization functionality can be used to suggest a full calendar of promotions, based on specific business rules.

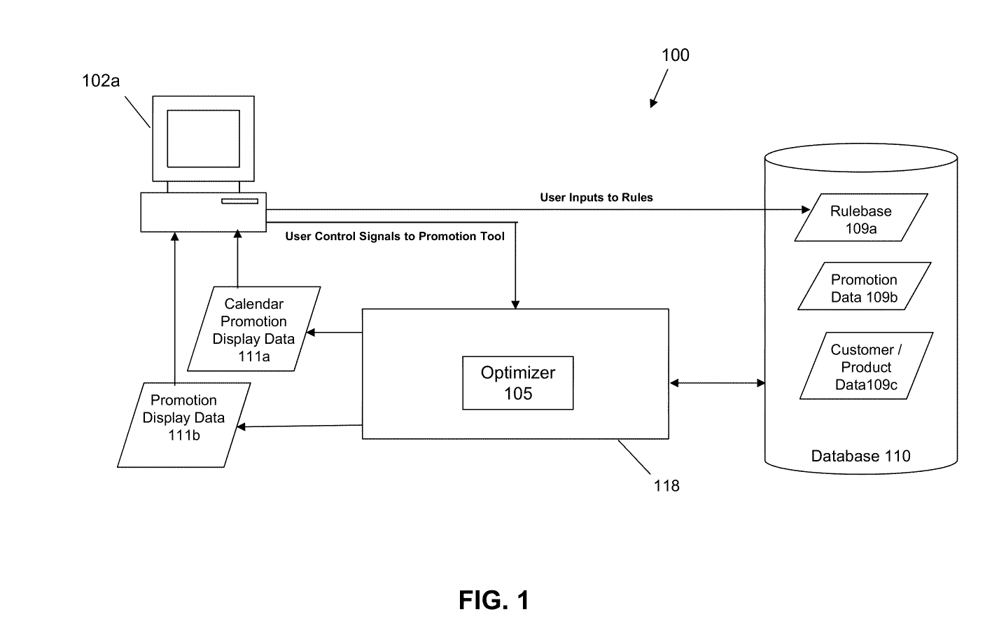

FIG. 1 shows an architecture of a system 100 for implementing promotion optimization functionality according to some embodiments of the invention. System 100 may include one or more users at one or more user stations 102a to access an enterprise software application on computing server/system 118. In system 100, user station 102a comprises any type of computing station that may be used to operate or interface with a server 118. Examples of such user stations 102a include for example, workstations, personal computers, laptop computers, or remote computing terminals. User station 102a may also be implemented as portable tablet device, including for example, tablet computers, portable readers, etc. In addition, the user station 102a may be implemented as a mobile device, such as smartphones and programmable mobile handsets. The user station 102a includes a display device, such as a display monitor or screen, for displaying scheduling data and interface elements to users. The user station 102a may also comprise one or more input devices for the user to provide operational control over the activities of system 100, such as a mouse, touch screen, keypad, or keyboard.

The users operate the system 100 to access and utilize applications on an application server 118 to perform any activities operable using the application server 118. For example, the server 118 may implement an enterprise software application such as the E-Business Suite, available from Oracle Corporation of Redwood Shores, Calif.

According to some embodiments of the invention, the enterprise software application comprises an optimizer 105 to optimize the implementation and handling of promotions by the enterprise software application. The optimizer operates upon customer/product data 109c to generate promotion data 109b. The customer/product data 109c and the promotion data 109b may be stored into a database 110 in a computer readable storage device. The computer readable storage device comprises any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

A rulebase 109a includes one or more rules for operating the optimizer 105. This makes it possible to optimize promotions across a solution space based on specific business rules and constraints. For example, the business rules can be used to limit causal values and combinations during operation of the optimizer 105. The promotion optimization functionality provided by the optimizer may include adding exclusions sets, improving the buy-down calculation, increased flexibility when entering event costs, better support for different causal types, and/or new parameters that provide greater flexibility. Buy-downs can be minimized as another solution, providing greater degrees of freedom. Configurable expressions are provided which allow greater flexibility in formulation and maintenance of fixed costs. In some embodiments, business constraints can be disabled, increasing the chance of finding a solution. A configurable baseline can be provided to allow the optimization to accept user overrides.

In some embodiments, the rules in rulebase 109a may be created, modified, or deleted by the users at user station 102a. This is in addition to, or instead of, system-provided rules that are not provided by the users.

Calendar Optimization is also provided by the optimizer in some embodiments. This functionality optimizes the promotional calendars using an optimization engine 105. The optimization permits a promotional calendar to be implemented which specifies budget, range of products, range of accounts, overall calendar time, and other constraints. The optimizer will create the promotion calendar based at least in part upon choice of best products, tactics, and timing of promotions. In some embodiments, the calendar optimization enables users to optimize more than one promotion at a time. The optimization functionality can be used to suggest a full calendar of promotions, based on specific business rules.

Promotion display data 111b may be generated and displayed at the user station 102a. Calendar promotion display data 111a may also be generated and displayed at the user station 102a.

The present invention provides numerous advantages. For example, the inventive promotion optimization approach can support variety of business rules and help to ensure results are not just mathematically optimal, but also make business sense. The use of additional parameters and more flexible controls in the invention permits the system to ease configuration and implementation for users. In addition, calendar optimization allows many promotions to automatically be analyzed and created at once without the need to interact with single promotions. This approach therefore provides an excellent starting point for creating a new promotional plan.

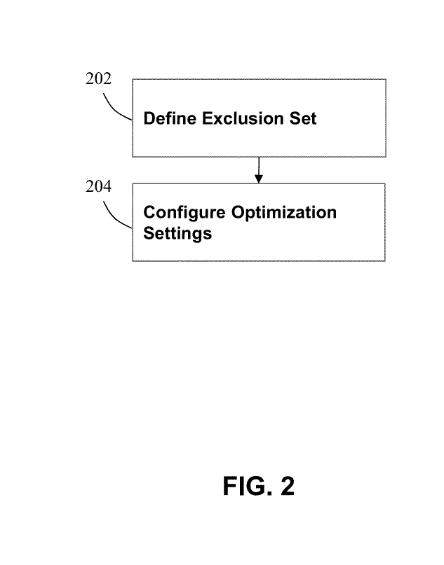

FIG. 2 shows a high level diagram of the setup flow for promotion optimization according to some embodiments of the invention. At 202, the first step when setting up promotion optimization is to define an exclusion set. An exclusion set defines a set of conditions that one does not want to occur in an optimized promotion. The exclusion sets include one or more exclusion rules. These rules can be manually created, e.g., by inserting rows into a table (e.g., named “TPO_EXCLUSION_RULES” table).

The following are defined for each exclusion rule in a set:

RULE_ID unique number for each rule set, where several rows can exist for same rule

CAUSAL_ID internal ID from causal factors table rule applies to

TRANSPOSE_ID internal ID from causal factors table rule applies to; If causal has no transpose, then set to 0

MIN_VAL and MAX_VAL range of values which the optimizer will exclude

LOC_DIM_ID, ITEM_DIM_ID members for which rule is applied

If Null then rule applied to all members in dimension

Members should match Item and Location aggregations passed to optimizer

The rules define which value ranges can and/or cannot be set for a specific causal. In addition, the rules allow different combinations of causals and values.

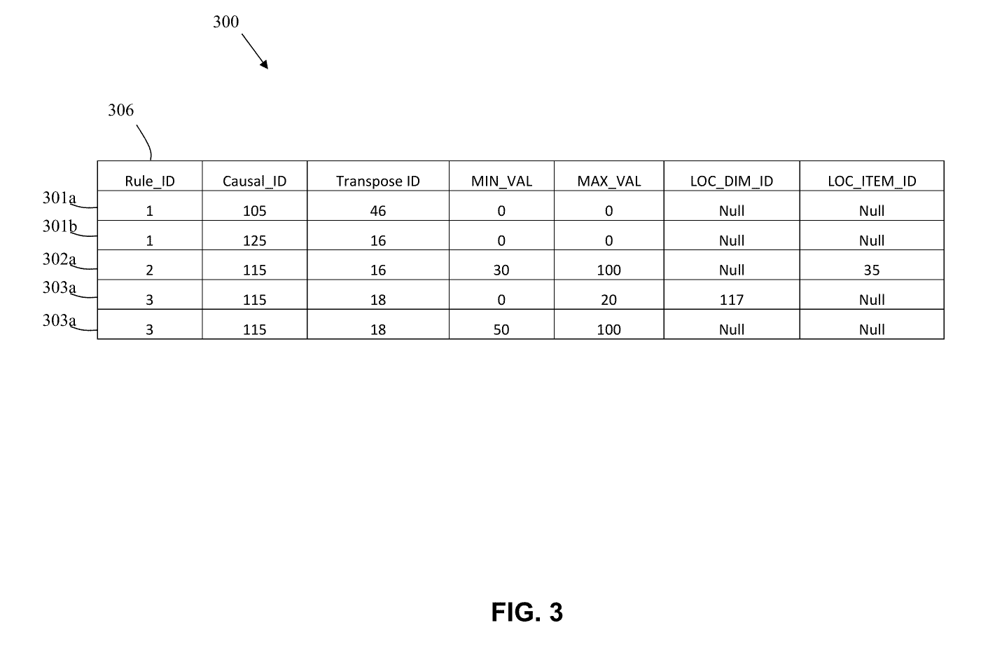

To illustrate, consider the example table 300 shown in FIG. 3. In this example three different rules are defined (identified as rules “1”, “2”, and “3” in the Rule_ID column 306). The first rule (rule “1” corresponding to rows 301a and 301b) ensures that causal 105 and 125 never occur together. The second rule (rule “2” corresponding to row 302a) states that location member with ID=35 cannot have causal 115 value between 30 and 100. The third rule (rule “3” corresponding to rows 303a and 303b) states that causal 115 cannot be between 0 and 20 for location member 117 and for all items and locations the causal cannot be between 50 and 100.

At 204, the second step in the flow of FIG. 2 is to configure optimization settings. Various parameters maybe used to configure the optimization process. Examples include parameters that set conditions for causal and transpose values that affect cost selection.

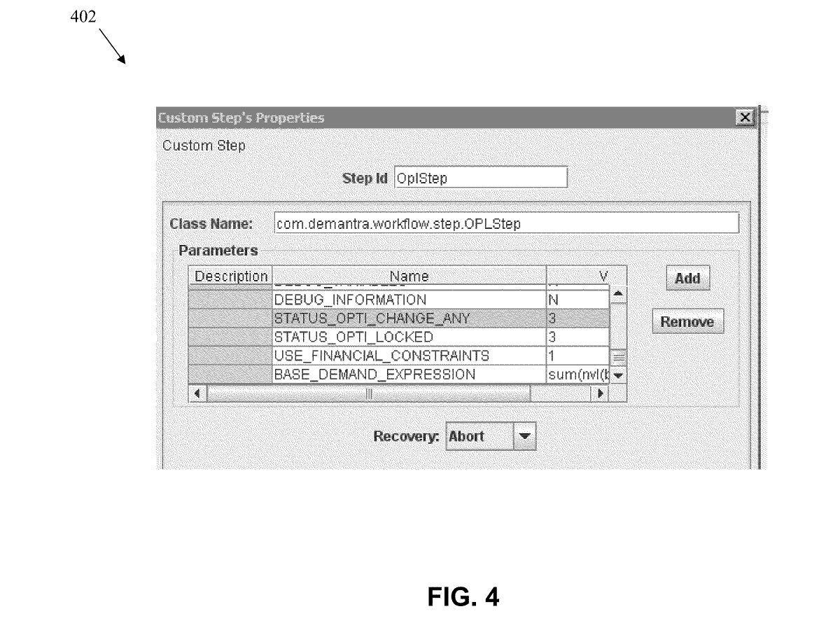

FIG. 4 shows an example approach that can be used to configure the optimization parameters. One or more parameters can be edited using, for example, an interface 402 as shown in FIG. 4. For example, for vehicle sales, the interface can be used to edit the Vehicle Cost, which is defined by the parameter MAN_VEHICLE_COST_EXPRESSION. This parameter can accept conditions for causal and transpose values to affect cost selection. The following shows an example formula that can be used:
avg((case #TRANSPOSE# when 25 then branch_data.FIXED_COST_OVER_{—}1 else branch_data.FIXED_COST_OVER end))
If transpose is 25 then use column fixed_cost_over_{—}1 otherwise fixed_cost_over

Other types of parameters may also be edited and configured. For example, settings can be configured to define a status value where lower status ID values indicate promotion can be modified while equal or higher status ID values indicate promotion is locked and cannot be modified. In some embodiments, these parameters are set to the same value. In addition, statuses are created in ordinal fashion where a specific value sets the threshold between promotions to be modified and locked.

Another parameter pertains to the use of financial constraints, where a given setting can be used to relax the constraints. Yet another parameter pertains to baseline expressions, which can be used to hold the expression that the optimization engine will use as a baseline forecast. This can be modified to consider forecast overrides.

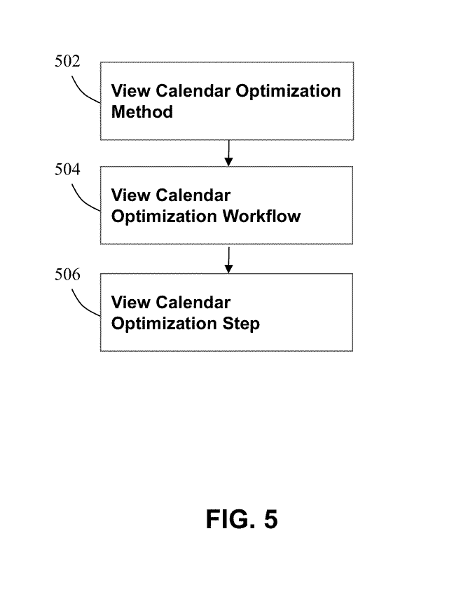

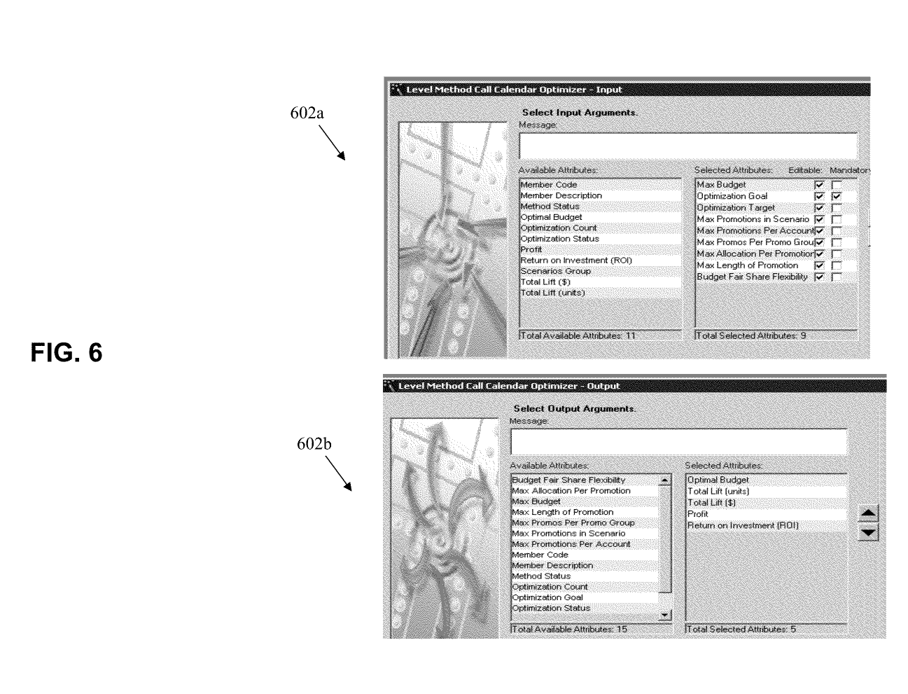

FIG. 5 illustrates a setup flow for calendar optimization. At 502, the first step is to view and/or configure the calendar optimization method. This step can be used to modify the input and output attributes for the calendar optimizer. FIG. 6 shows example approach that can be used to implement this step. The interfaces 602a and 602b in FIG. 6 include one or more configuration menus pertaining to the settings that can be configured. Example input attributes/arguments and output attributes/arguments that can be configured in this step are shown in FIG. 6. These attributes include, for example for inputs, member code, member description, method status, optimal budget, optimization count, optimization status, profit, return on investment, scenarios groups, and total lift (in units or dollar amount). These attributes also include, for example for outputs, budget fair share flexibility, maximum allocation per promotion, maximum budget, maximum length of promotion, maximum promotions per promo group, maximum promotions in a scenario, maximum promotions per account, member code, member description, method status, optimization count, optimization goal, and optimization status. The attributes can be enabled, selected, and/or edited.

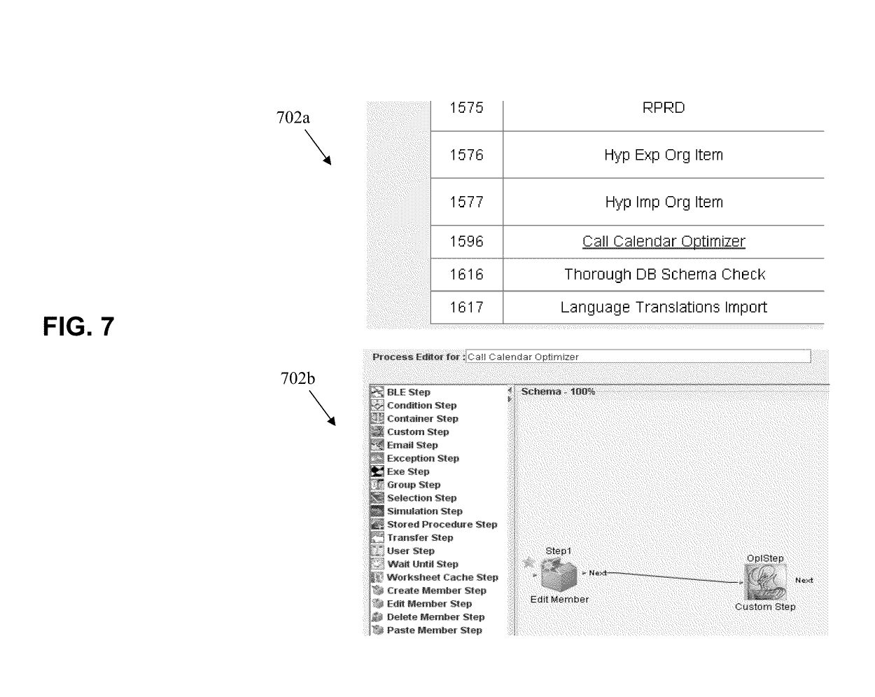

At 504, the next step is to view and/or configure the optimization workflow. The optimization workflow includes one or more workflow steps. FIG. 7 shows example approach that can be used to view/edit the workflow definitions, along with a partial list of workflow steps that can be viewed/edited. In particular, a graphical user interface (such as interface windows 702a and 702b) can be used to view/edit the workflow definitions.

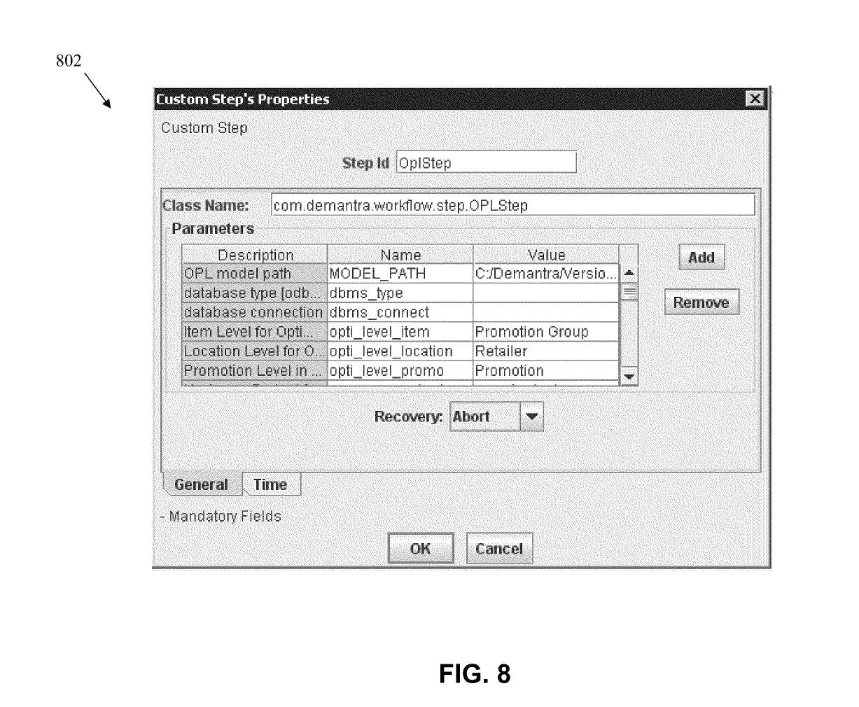

At 506, the final step is to view and/or configure the optimization definitions. In some embodiments, these should be set similar to the promotion optimization parameter definitions. FIG. 8 shows an example approach that can be taken to view/configure the optimization definitions. The definitions include, for example, parameter names, values, and descriptions. For example, interface 802 can be used to view/configure the optimization definitions.

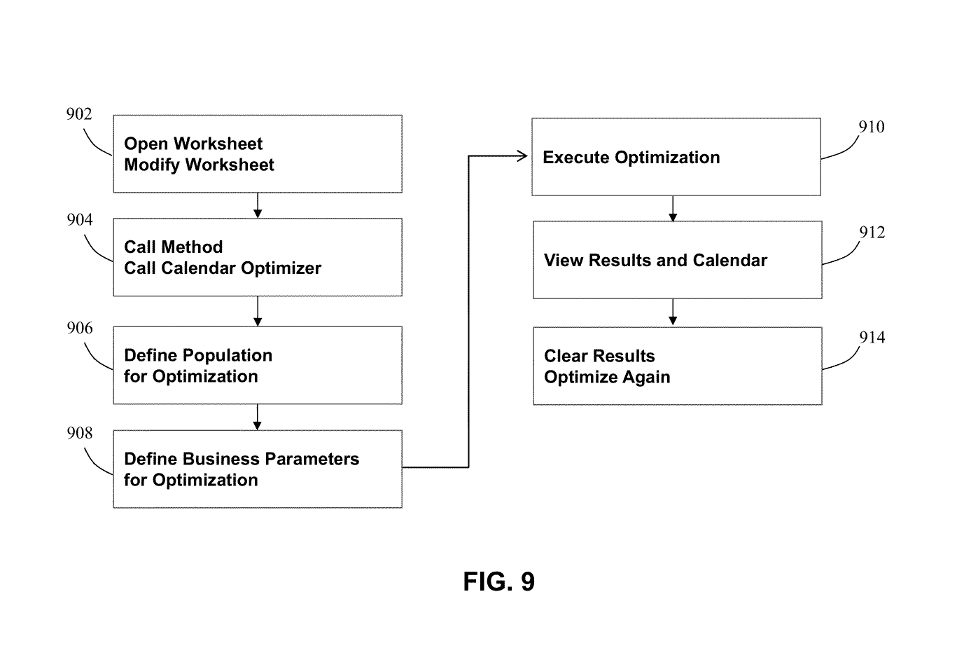

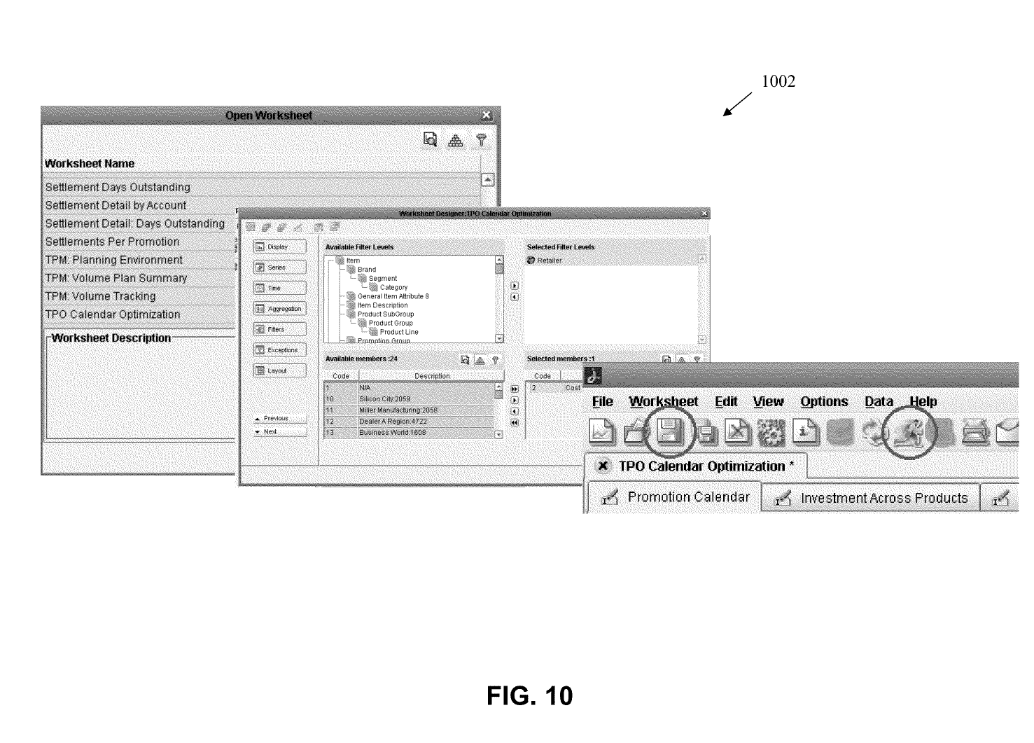

FIG. 9 shows a process flow to perform the calendar optimization. At 902, the first step is to open and modify the worksheet for the optimization. The worksheet settings are edited to include desired filters and dates for the optimizations. FIG. 10 shows an example approach that can be taken, where interface 1002 is be used to open and configure the optimization worksheet.

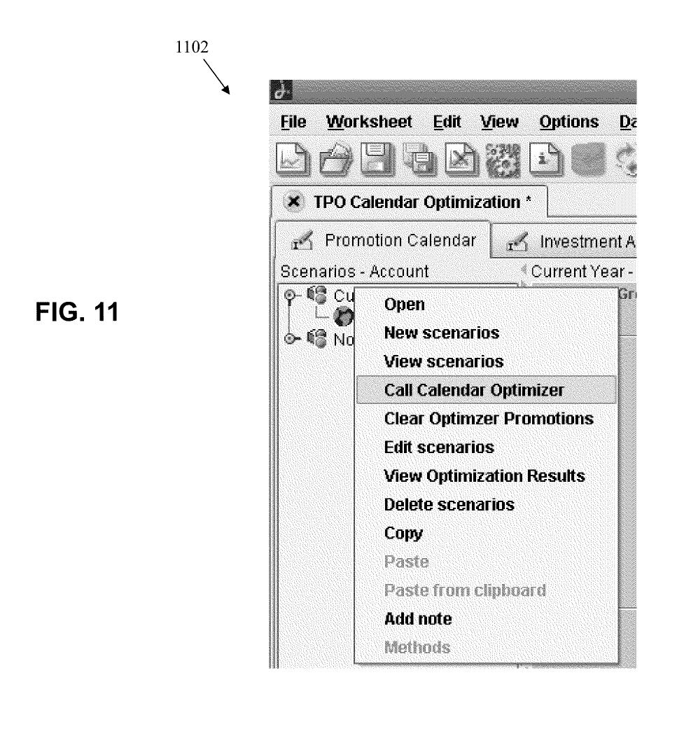

At 904, the next step is to call the calendar optimizer. FIG. 11 shows an example approach that can be used, where an interface 1102 is operable to click on the correct scenario level, and to then choose the “Call Calendar Optimizer” method.

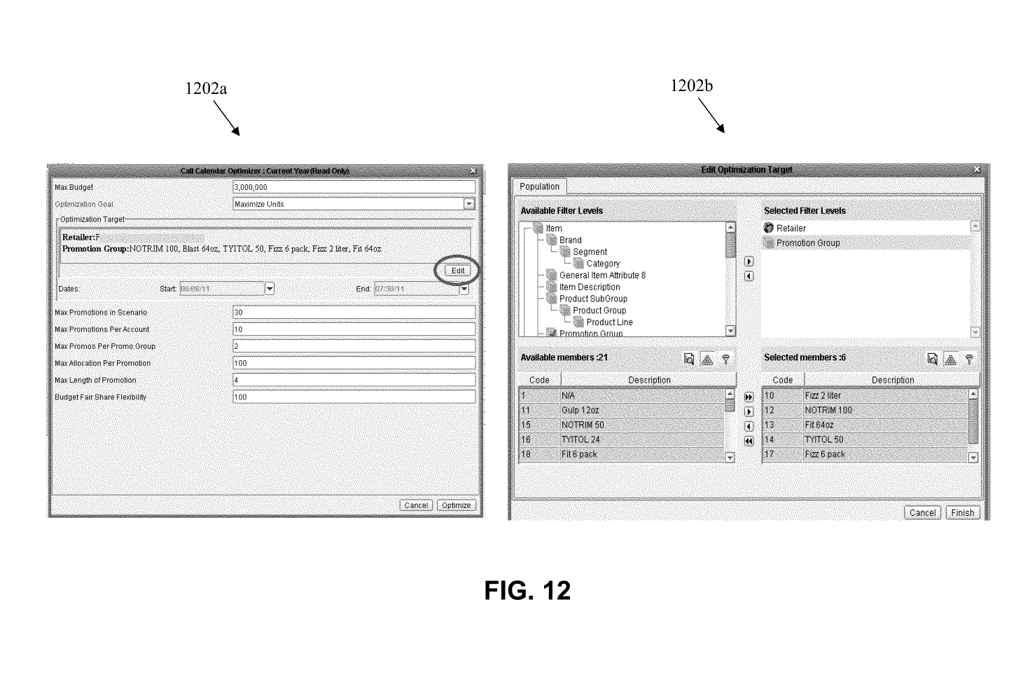

The population is then defined for the optimization at 906. FIG. 12 shows an example approach that can be taken to perform this action. This action is performed by reviewing the population of the optimization target, e.g., as implemented in the interface 1202a-b of FIG. 12. The user then edits/modifies the population. For example, the interface permits the user to edit and modify the population, e.g., in terms of products and/or product groups. The population of the optimization target and the calendar optimization parameters appear in the dialog shown in the figure, which can be used to review the target population and optimization parameters. The optimization target parameter defines the accounts and products that the optimizer will evaluate as possible places to promote when selecting the optimal calendar. In some embodiments, all promotions created by the calendar optimizer are created within the optimization target. In this embodiment, optimization will only run on the population chosen in the target and will generate promotions only within this population.

At 908, the next step is to define the business parameters for the optimization. The user reviews and optionally modifies the calendar optimization parameters in this step. When the method is executed, these settings are persisted for the scenario and are available the next time optimization is run for this scenario. The following are example parameters that can be used for the optimization range:
Maximum Budget is the maximum amount of funds the optimizer can spend across all promotion in the scenario.
Optimization Goal refers to the business goal the optimizer will focus on across all promotions in the scenario. Can be set to Maximize Units, Maximize Revenue and Maximize Profit.
Dates Start and Dates End define the time range to be evaluated during the calendar optimization. The Optimizer selects the optimal time and products and places to promote within the Optimization Target.
Max Promotions in Scenario defines the maximum number of promotions the optimizer can create or maintain in the Scenario.
Max Promotions Per Account defines the maximum number of promotions the optimizer can create or maintain in each account.
Max Promos Per Promo Group defines the maximum number of promotions the optimizer can create or maintain for each Promotion Group per Account.
Max Allocation Per Promotion is the maximum % budget allocation any single promotion will get of the total budget used in the scenario.
Max Length of Promotion defines the maximum number of periods for any single promotion created in the scenario.
Budget Fair Share Flexibility defines the flexibility the optimizer has to spend funds outside the allocation of budget according to sales revenue share. The larger the number the more flexibility the optimizer has to spend funds outside a fair share sales allocation.

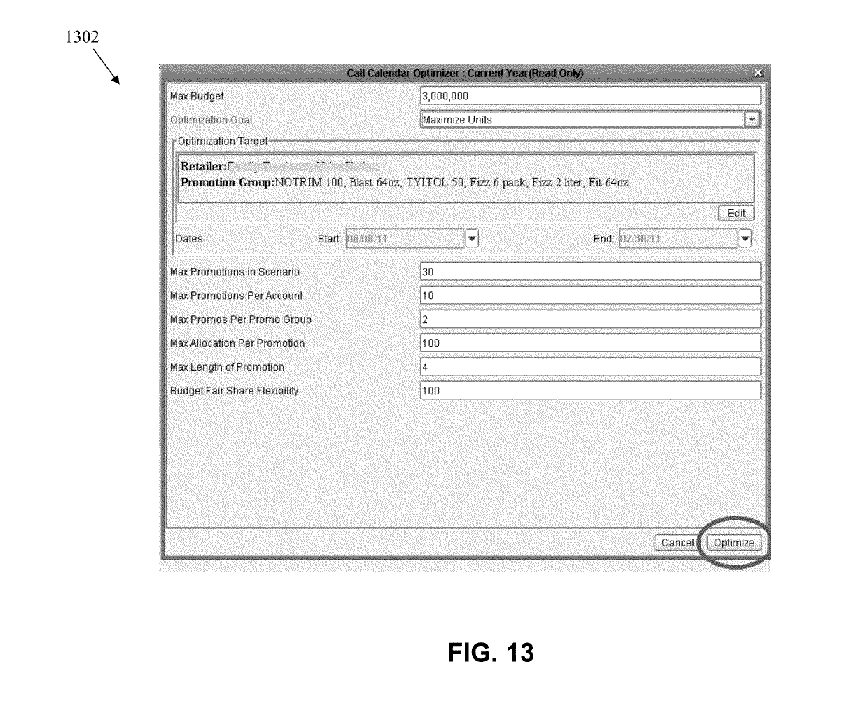

The next step is to execute the calendar optimization at 910. This action takes the configured business parameters and the rules, and performs processing to create a promotion calendar. This creates a solution set of promotions for calendaring which satisfies the business parameters, and which is created using the rules in the rule base. As noted above, constraints may be turned on and/or off to increase the possible solution space. FIG. 13 shows an example approach for executing the calendar optimization, e.g., by using an interface such as interface 1302. This interface includes additional parameters that can be edited for executing the optimization.

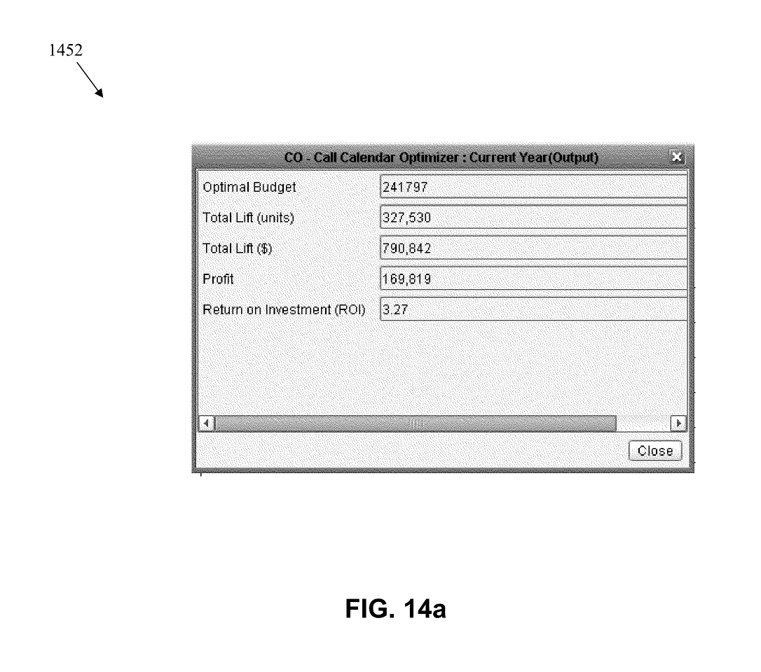

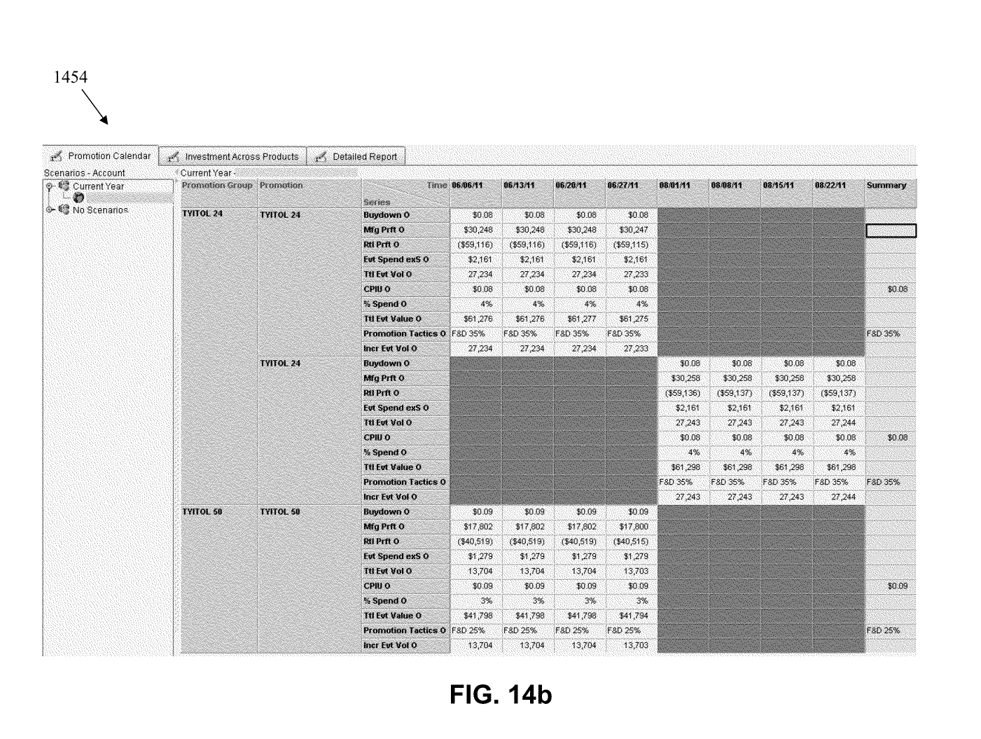

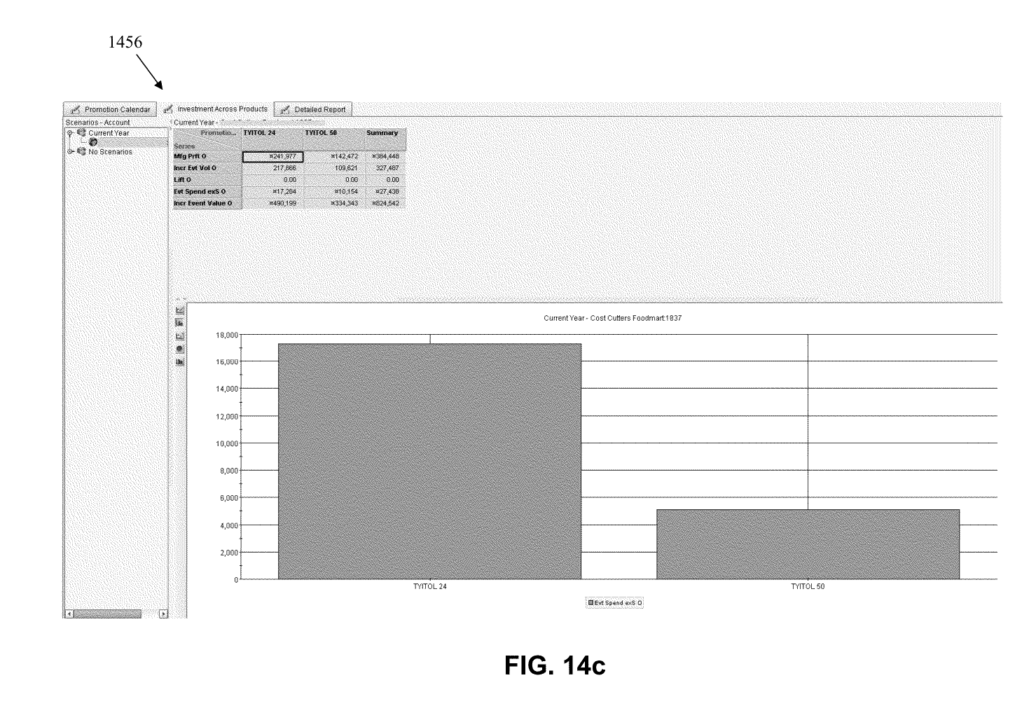

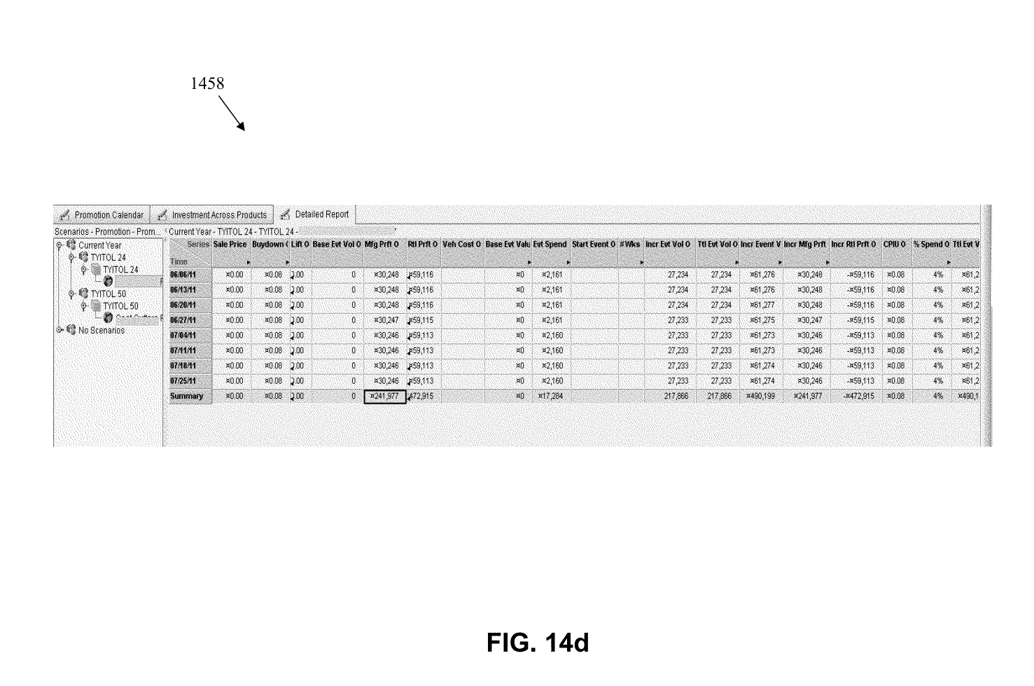

After the calendar optimization process completes, various output screens can be used to display the results. FIG. 14a shows an example interface 1452 to view the optimization results. This interface screen displays the following information:
Optimal Budget is the amount of funds the Optimizer spent in this Scenario.
Total Lift(Units) is the total amount of Incremental Units generated in this Scenario. Negative values indicate a reduction in total units associated with the scenario.
Total Lift($) is the total amount of Incremental Dollars generated in the Scenario. The value specifies a net dollar change from the previous scenario.
Profit is the total profit for all promotions in the scenario.
Return on Investment (ROI) is calculated as (Total Lift $)/Investment (Optimal Budget) and represents the overall return on investment of the selected scenario.

The optimization results can also be displayed in a calendar optimization worksheet, or any worksheet that can handle the Promotion hierarchy and the Scenarios level. This interface permits the user to review the results in tabs corresponding to the Promotion Calendar, Investment Across Products, and Detailed Reports.

FIG. 14b shows an example interface 1454 to display the Promotion Calendar tab. The Promotion Calendar tab shows the calendar of promotions in the scenario laid out across products and time for each account. Blank areas indicate no promotions for the specific account/product/date.

FIG. 14c displays an example interface 1466 for the Investment Across Products tab, which contains a graph that shows how the optimizer allocated the funds across the products that it selected for optimization. The table shows additional data on how the investment, return and profit varied across the products promoted by the optimizer. This tab can serve as a basis for viewing fund allocation and results across other dimensions, including accounts and product groups

FIG. 14d displays an example interface 1458 for the Detailed Report tab, which shows the promotions that are associated with the scenario at a granular level. The Detailed Report tab shows settings and impacts at granular promotion and date level. This tab displays individual promotions by Item Group, Account, and date. For each date, effects of a promotion can be viewed and analyzed using this interface.

The final step in the flowchart of FIG. 9 at 914 is to save the desired promotions and to clear the results. When the optimizer is executed, it will respect any promotions already defined for the population being optimized. For promotions with a status of ‘Planned,’ the optimizer may modify promotional attributes such as ‘discount’, but will keep promotion type and dates as defined. Promotions with status of ‘committed’ will be used as defined and cannot be changed.

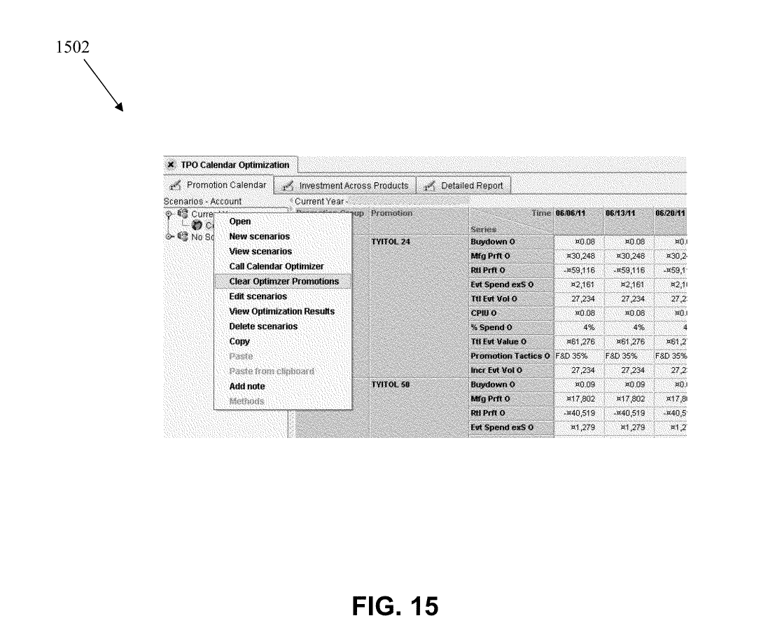

Any promotions created during calendar optimization will receive a status of ‘Proposed’. To persist these promotions between optimizer runs, the promotion status be changed to either “Planned” or “Committed”. A user can remove any promotions created by the optimizer that still have a status of “proposed’ by executing the method “Clear Optimizer Promotions.” FIG. 15 shows an example approach that can be used to save the promotions and to clear the results, e.g., using interface 1502.

Therefore, what has been described is an improved approach to implement optimization of promotions in an enterprise software system. Promotion optimization functionality is provided to permit customer controlled rules to be processed for the promotions. The promotion optimization functionality in some embodiments include adding exclusions sets, improving the buy-down calculation, increased flexibility when entering event costs, better support for different causal types, and/or new parameters that provide greater flexibility.

Calendar Optimization is also provided in some embodiments, which enables users to optimize more than one promotion at a time. The optimization functionality can be used to suggest a full calendar of promotions, based on specific business rules.

The present invention provides numerous advantages, such as for example, the ability to support variety of business rules and help to ensure results are not just mathematically optimal, but also make business sense. The use of additional parameters and more flexible controls in the invention permits the system to ease configuration and implementation for users. In addition, calendar optimization allows many promotions to automatically be analyzed and created at once without the need to interact with single promotions. This approach therefore provides an excellent starting point for creating a new promotional plan.

System Architecture Overview

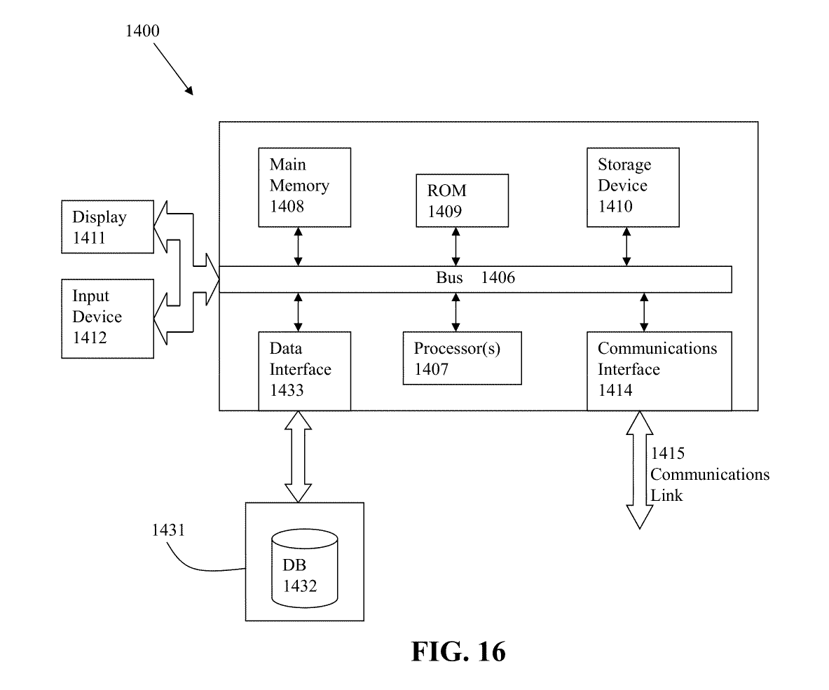

FIG. 16 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Data may be stored in a database 1432 on a storage medium 1431 which is accessed through data interface 1433.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method implemented with a processor, comprising:
identifying rules corresponding to one or more promotions;
using an optimizer to optimize the one or more promotions using the rules; and
implementing the one or more promotions using an enterprise application.

2. The method of claim 1, in which optimization functionality is provided for at least one of adding exclusions sets, implementing a buy-down calculation, entering event costs, and support for causal types.

3. The method of claim 1, in which the rules are used to limit causal values during operation of an optimizer.

4. The method of claim 1, in which business constraints are disabled.

5. The method of claim 1, in which calendar optimization is performed.

6. The method of claim 5, in which a calendar of promotions is provided using the rules.

7. The method of claim 5, in which a promotional calendar is implemented which specifies at least one of budget, range of products, range of accounts, and overall calendar time.

8. The method of claim 5, in which a promotional calendar is implemented based at least in part upon choice of best products, tactics, timing of promotions, or any combination thereof.

9. The method of claim 1, in which the rules correspond to an exclusion set.

10. The method of claim 1, in which a business parameter is configured for the promotion optimization, including at least one of Maximum Budget; Optimization Goal, Dates Start and Dates End, Max Promotions in Scenario, Max Promotions Per Account, Max Promos Per Promo Group, Max Allocation Per Promotion, Max Length of Promotion, and Budget Fair Share Flexibility.

11. A tangible computer readable medium having stored thereon a sequence of instructions which, when executed by a processor causes the processor to execute a method, comprising:
identifying rules corresponding to one or more promotions;
using an optimizer to optimize the one or more promotions using the rules; and
implementing the one or more promotions using an enterprise application.

12. The computer readable medium of claim 11, in which optimization functionality is provided for at least one of adding exclusions sets, implementing a buy-down calculation, entering event costs, and support for causal types.

13. The computer readable medium of claim 11, in which the rules are used to limit causal values during operation of an optimizer.

14. The computer readable medium of claim 11, in which business constraints are disabled.

15. The computer readable medium of claim 11, in which calendar optimization is performed.

16. The computer readable medium of claim 15, in which a calendar of promotions is provided using the rules.

17. The computer readable medium of claim 15, in which a promotional calendar is implemented which specifies at least one of budget, range of products, range of accounts, and overall calendar time.

18. The computer readable medium of claim 15, in which a promotional calendar is implemented based at least in part upon choice of best products, tactics, timing of promotions, or any combination thereof.

19. The computer readable medium of claim 11, in which the rules correspond to an exclusion set.

20. The computer readable medium of claim 11, in which a business parameter is configured for the promotion optimization, including at least one of Maximum Budget; Optimization Goal, Dates Start and Dates End, Max Promotions in Scenario, Max Promotions Per Account, Max Promos Per Promo Group, Max Allocation Per Promotion, Max Length of Promotion, and Budget Fair Share Flexibility.

21. A system, comprising:
a processor;
a memory;
a rulebase in the memory that is accessed comprising rules corresponding to one or more promotions; and
an optimizer that utilizes the processor and memory to perform optimization on the promotions using the rules.

22. The system of claim 21, in which optimization functionality is provided for at least one of adding exclusions sets, implementing a buy-down calculation, entering event costs, and support for causal types.

23. The system of claim 21, in which the rules limit causal values during operation of an optimizer.

24. The system of claim 21, in which business constraints are disabled.

25. The system of claim 21, in which calendar optimization is performed.

26. The system of claim 25, in which a calendar of promotions is provided using the rules.

27. The system of claim 25, in which a promotional calendar is implemented which specifies at least one of budget, range of products, range of accounts, and overall calendar time.

28. The system of claim 25, in which a promotional calendar is implemented based at least in part upon choice of best products, tactics, timing of promotions, or combinations thereof.

29. The system of claim 21, in which the rules correspond to an exclusion set.

30. The system of claim 21, in which a business parameter is configured for the promotion optimization, including at least one of Maximum Budget; Optimization Goal, Dates Start and Dates End, Max Promotions in Scenario, Max Promotions Per Account, Max Promos Per Promo Group, Max Allocation Per Promotion, Max Length of Promotion, and Budget Fair Share Flexibility.
